(19) United States
(12) Patent Application Publication
(10) Pub. No.: US 2025/0122980 A1
(43) Pub. Date: Apr. 17, 2025

(54) SUBMERGED PUMP AND SUMP ASSEMBLIES FOR USE WITH CRYOGENIC FLUIDS

(71) Applicant: Acme Cryogenics, Inc., Allentown, PA (US)

(72) Inventors: David Michael Rakos, Lehighton, PA (US); James David Edge, Riegelsville, PA (US)

(21) Appl. No.: 18/917,551

(22) Filed: Oct. 16, 2024

Related U.S. Application Data
(60) Provisional application No. 63/590,698, filed on Oct. 16, 2023.

(51) Int. Cl. F17C 7/02; F04B 15/08

(52) U.S. Cl. CPC F17C 7/02; F04B 15/08; F17C 2203/0391; F17C 2227/0135; F17C 2227/0178; F17C 2250/0408

(57) ABSTRACT

Submerged pump and sump assemblies for use with cryogenic fluids are disclosed. A sump assembly includes an external shell defining an internal volume, a top plate, and an intermediate flange disposed in the internal volume. The intermediate flange is positioned below and spaced apart from the top plate. The sump assembly includes an internal sleeve sealingly fixed to and extending between the top plate and the intermediate flange. The internal sleeve, the top plate, and the intermediate flange define an upper vacuum area. The sump assembly includes a casing forming an internal sump. The casing is positioned below and sealingly engages the intermediate flange. The casing and the external shell at least partially define an outer vacuum area. At least a portion of the outer vacuum area is located radially between the casing and the external shell. The sump assembly includes a pump submerged in the internal sump.

### CROSS-REFERENCE TO RELATED APPLICATION

This application claims the benefit of U.S. Provisional Patent Application No. 63/590,698, filed on Oct. 16, 2023, which is incorporated herein by reference in its entirety.

### TECHNICAL FIELD

This disclosure generally relates to sump and pump assemblies and more particularly, to such systems for use with cryogenic fluids.

### BACKGROUND

Cryogenic fluids are increasingly used in a variety of applications, including as fuel for machines such as vehicles. Cryogenic fluids are extremely cold and are required to be stored at cryogenic temperatures (e.g., temperatures less than −150 degrees Celsius), in for example, storage tanks. Cryogenic fluids are oftentimes transferred from a storage tank to another container for subsequent use.

Some known methods for transferring cryogenic fluids rely on pressure differentials between the storage tank and other container, which can result in a slow transfer and can be very time consuming. Other known methods use pumps to transfer cryogenic fluids, which can result in excessive heat transfer to the cryogenic fluid and/or freezing of the pump components.

### SUMMARY

Submerged pump and sump assemblies are disclosed herein for use with cryogenic fluids and, in particular, with liquid hydrogen, which can reach temperatures of −425 degrees Fahrenheit, for transferring such fluid from a tank or other receptacle, such as a tank disposed on a trailer, to a different tank or receptacle. The term “cryogenic fluids” as used herein will be understood to include liquid hydrogen and other such fluids. The assemblies disclosed herein provide sufficient insulation in a cost-effective and efficient manner to permit the use of a submersible pump in connection with such fluid transfer. Further, assemblies disclosed herein are configured to permit access to the submerged pump for repair or service without disassembly of the entire assembly.

### BRIEF DESCRIPTION OF THE DRAWINGS

FIG. 1 depicts a perspective view of a submersible pump and sump assembly in accordance with the teachings hereof.

FIG. 2 depicts a top view of the assembly of FIG. 1.

FIG. 3 depicts a cross-sectional view of the assembly of FIG. 1, along the lines B-B.

FIG. 4 depicts a cross-sectional view of the assembly of FIG. 1, along the lines A-A.

FIG. 5 depicts a cross-sectional view of the assembly of FIG. 1, along the lines C-C.

FIG. 6 depicts a cross-sectional view of a portion of the assembly of FIG. 1, along the lines B-B.

FIG. 7 depicts the assembly of FIG. 1 with the outer shell removed for clarity.

FIG. 8 a perspective view of another submersible pump and sump assembly in accordance with the teachings hereof.

FIG. 9 depicts a cross-sectional view of the assembly of FIG. 8.

FIG. 10 depicts a cross-sectional view of a lower body of the assembly of FIG. 8.

FIG. 11 depicts a cross-sectional view of an upper body of the assembly of FIG. 8.

### DETAILED DESCRIPTION OF THE DRAWINGS

The description that follows describes, illustrates and exemplifies one or more embodiments of the present invention in accordance with its principles. This description is not provided to limit the invention to the embodiments described herein, but rather to explain and teach the principles of the invention in order to enable one of ordinary skill in the art to understand these principles and, with that understanding, be able to apply them to practice not only the embodiments described herein, but also other embodiments that may come to mind in accordance with these principles. The present specification is intended to be taken as a whole and interpreted in accordance with the principles of the present invention as taught herein and understood by one of ordinary skill in the art.

The scope of the present invention is intended to cover all such embodiments that may fall within the scope of the appended claims, either literally or under the doctrine of equivalents. The specification describes exemplary embodiments which are not intended to limit the claims or the claimed inventions. Features described in the specification, but not recited in the claims, are not intended to limit the claims.

It should be noted that in the description and drawings, like or substantially similar elements may be labeled with the same reference numerals. However, sometimes these elements may be labeled with differing numbers, such as, for example, in cases where such labeling facilitates a clearer description. Additionally, the drawings set forth herein are not necessarily drawn to scale, and in some instances, proportions may have been exaggerated to more clearly depict certain features. Such labeling and drawing practices do not necessarily implicate an underlying substantive purpose.

Some features may be described using relative terms such as top, bottom, vertical, rightward, leftward, etc. It should be appreciated that such relative terms are only for reference with respect to the appended drawings. These relative terms are not meant to limit the disclosed embodiments.

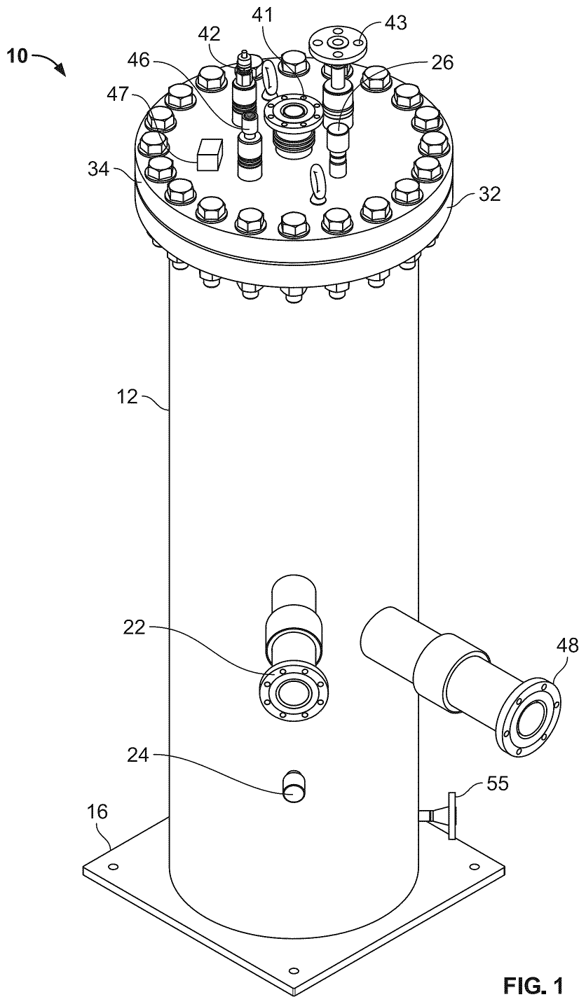

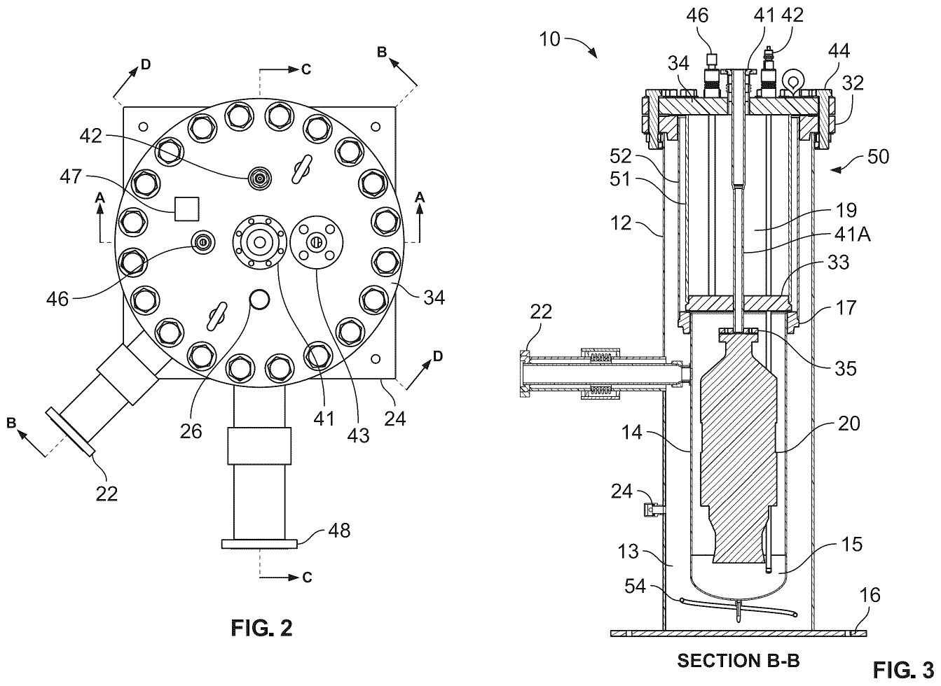

Turning to FIGS. 1-7, which depicts an exemplary cryogenic pump and sump assembly 10 (also referred to as “sump assembly”) having insulated external shell 12 (also referred to as “shell” and “external shell”) and mounting plate 16. Shell 12 extends vertically and includes an upper end and a lower end. Mounting plate 16 is sealingly coupled (e.g., welded) to the lower end of shell 12 and is configured for mounting sump assembly 10 on a trailer or another external surface (not shown). Shell 12 forms an internal volume in which vacuum area 13 (also referred to as “first vacuum area,” “outer vacuum area,” and “outer radial vacuum area”) is formed.

As shown in FIGS. 3-5, sump assembly 10 includes cryogenic casing 14 (also referred to as “casing”) that is disposed in shell 12. Casing 14 forms internal sump 15 for receiving the cryogenic fluid. Cryogenic pump 20 (also referred to as “pump”) of sump assembly 10 is submerged in internal sump 15. Pump 20 may be of standard design for a pump capable of pumping cryogenic fluid such as liquid hydrogen. As shown in FIG. 5, sump assembly 10 includes inlet 48 through which cryogenic fluid is ported into internal sump 15. Inlet 48 extends through shell 12 and is sealingly connected to casing 14 to fluidly connect internal sump 15 to an external source tank (not shown). Inlet 48 is configured to fluidly connect internal sump 15 to the external source by means of a vacuum jacketed tube (not shown). In the illustrated example, inlet 48 is a dual seal 2″ by 4″ bayonet, Part No. C-07303, sold by Acme Cryogenics, Inc. of Allentown, PA. Inlet 48 of the illustrated example is a female bayonet connector to facilitate a semi-permanent installation of sump assembly 10 in the field. It should be appreciated that in other examples, the inlet 48 may be a field can configuration that facilitates a permanent installation of the sump assembly 10 in the field.

Sump assembly 10 includes vacuum pumpout 24 (also referred to as “first vacuum pumpout” and a “outer vacuum pumpout”) that is configured to create a vacuum (also referred to as “first vacuum,” “outer vacuum,” and “outer radial vacuum”) in vacuum area 13. As shown in FIG. 3, vacuum pumpout 24 extends through shell 12 and is sealingly connected to casing 14 to enable the first vacuum to be created in vacuum area 13. As shown in FIGS. 3-5, at least a portion of vacuum area 13 is located radially between casing 14 and shell 12 to minimize heat transfer between internal sump 15 and the external atmosphere. As used herein, the term “vacuum” is intended to mean a vacuum within standard engineering tolerances for the relevant cryogenic fluids.

In the illustrated example, sump assembly 10 also includes lower body 25 (also referred to as “lower portion,” “fixed body,” and “fixed portion”) and upper body 30 (also referred to as “upper portion,” “removable body,” and “removable portion”). As disclosed below in greater detail, upper body 30 is removable from lower body 25 to provide easy access to and removability of pump 20 without further disassembly of sump assembly 10.

Lower body 25 includes shell 12, casing 14, and mounting plate 16 such that lower body 25 is fixed to a trailer when mounting plate 16 is mounted to the trailer. Lower body 25 also includes inlet 48 and vacuum pumpout 24 that are sealingly connected to casing 14. In the illustrated example, lower body 25 also includes top flange 32, external sleeve 52, and sealing body 17. An outer portion of top flange 32 is sealingly fixed (e.g., welded) to the upper end of shell 12. External sleeve 52 (also referred to as “outer sleeve” and “female sleeve”) is sealingly fixed (e.g., welded) to a separate portion of top flange 32 and extends downwardly from top flange 32. External sleeve 52 is concentrically aligned with and spaced radially inward relative to shell 12. External sleeve 52 is also sealingly fixed (e.g., welded) to and extends upwardly from sealing body 17. Sealing body 17 also sealingly engages a top portion of casing 14. For example, sealing body 17 is sealingly fixed (e.g., welded) to and around a periphery of casing 14.

Upper body 30 includes top plate 34, intermediate flange 33, and internal sleeve 51 (also referred to as “outer sleeve” and “female sleeve”). Top plate 34 is positioned adjacent to the upper end of shell 12. Internal sleeve 51 extends vertically between and is sealingly fixed (e.g., welded) to top plate 34 and intermediate flange. For example, intermediate flange 33 is fixed to a bottom portion of internal sleeve 51, and top plate 34 is fixed to an upper portion of internal sleeve 51. Intermediate flange 33, internal sleeve 51, and top plate 34 of upper body 30 form vacuum area 19 (also referred to as “second vacuum area” and “upper vacuum area”). Sump assembly 10 further includes vacuum pumpout 26 (also referred to as “second vacuum pumpout” and an “upper vacuum pumpout”) that is disposed on top plate 34 to create a vacuum in vacuum area 19.

As shown most clearly in FIGS. 3-5, sump assembly 10 includes discharge connection 41 that is fluidly connected to top of pump 20. Discharge connection 41 is coupled top plate 34, and a top end of pump 20 is coupled (e.g., bolted) to pump flange 35 of upper body 30. Discharge pipe 41a extends through top plate 34, vacuum area 19, and intermediate flange 33 to fluidly connect discharge connection 41 and pump 20. Pump flange 35 is fixed to an end of discharge pipe 41a that extends below intermediate flange 33. In the illustrated example, discharge connection 41 is a bayonet-style connection, although other types of connections can be used.

Top plate 34 of upper body 30 is removably couplable to top flange 32 of lower body 25 via a plurality of fasteners 44 to removably attach upper body 30 to lower body 25. Removal of top plate 34 enables easy access to and removability of pump 20 without further disassembly of the sump assembly 10. When upper body 30 is attached to lower body 25, top plate 34 is sealingly attached to top flange 32. Sump assembly 10 may include a gasket (not shown) positioned between top plate 34 and top flange 32 to form a sealed connection between top plate 34 and top flange 32. Further, a surface of intermediate flange 33 sealingly engages and couples to a top surface of sealing body 17 to seal off internal sump 15 (e.g., via a glass-reinforced Teflon cold seal). In the illustrated example, the top surface of sealing body 17 is configured to form a flat-based seal with a bottom surface of intermediate flange 33.

When upper body 30 is sealingly coupled to lower body 25 in such a manner, vacuum area 13 is defined by shell 12, casing 14, mounting plate 16, external sleeve 52, top flange 32, and sealing body 17. Vacuum areas 13, 19 are arranged such that an upper portion of vacuum area 13 is positioned radially between vacuum area 19 and shell 12. External sleeve 52 is positioned radially between internal sleeve 51 and shell 12 to create a radial buffer between vacuum area 19 and an upper portion of vacuum area 13. That is, sump assembly 10 of the illustrated example includes heat path transition assembly 50 that includes internal sleeve 51 and external sleeve 52. Heat path transition assembly 50 is located vertically between pump 20 and top plate 34 such that vacuum area 19 is positioned vertically above pump 20.

The length(s) of internal sleeve 51 and/or external sleeve 52 of heat path transition assembly 50 cause pump 20 and discharge connection 41 to be spaced apart by at least a height of the second vacuum extending between intermediate flange 33 and top plate 34, thereby minimizing heat transfer from the cryogenic fluid as the cryogenic fluid passes through discharge pipe 41a for discharge from discharge connection 41. That is, the combination of vacuum areas 13, 19 and the distance between pump 20 and discharge connection 41 to minimize heat transfer with the external atmosphere.

In the illustrated example, sump assembly 10 also includes vent 22. As shown in FIG. 3, vent 22 extends through shell 12 and is sealingly connected to casing 14 to fluidly connect to internal sump 15. Vent 22 is fluidly connected to internal sump 15 to provide venting of excess fluid to an external location, such as the source tank. Vent 22 of the illustrated example is a female bayonet connector to facilitate a semi-permanent installation of sump assembly 10 in the field.

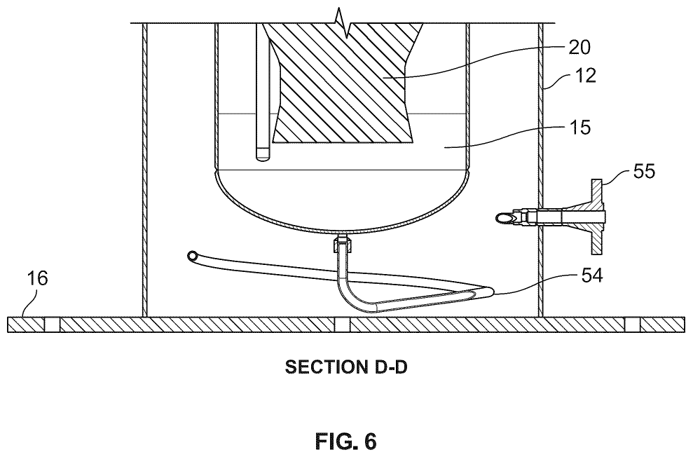

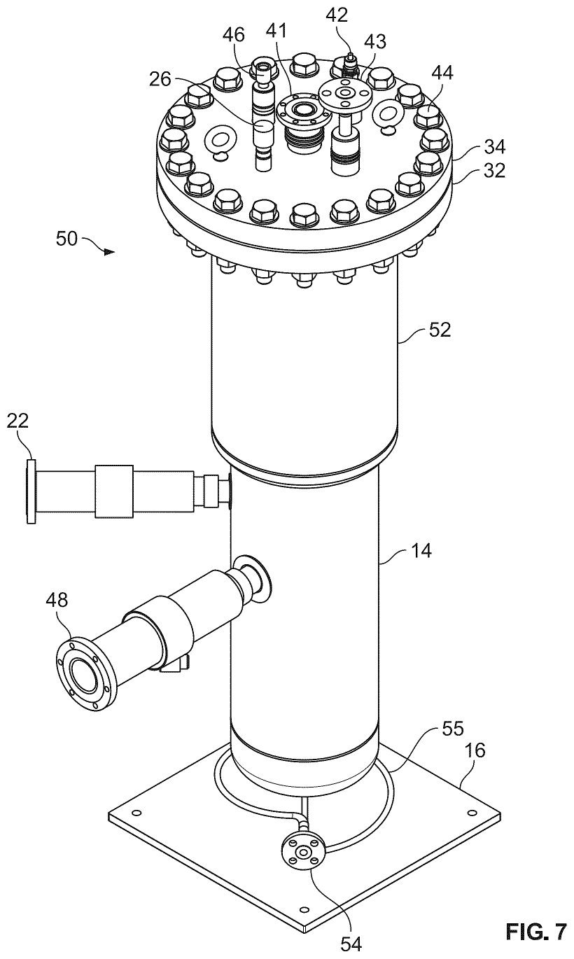

As shown in FIGS. 6-7, sump assembly 10 includes drain 55 and tubing 54. Drain 55 is coupled to and extends outwardly from shell 12. Tubing 54 extends between and fluidly connects pump 20 and drain 55 to enable drain 55 to drain fluid from internal sump 15. In some examples, tubing 54 is composed of stainless steel.

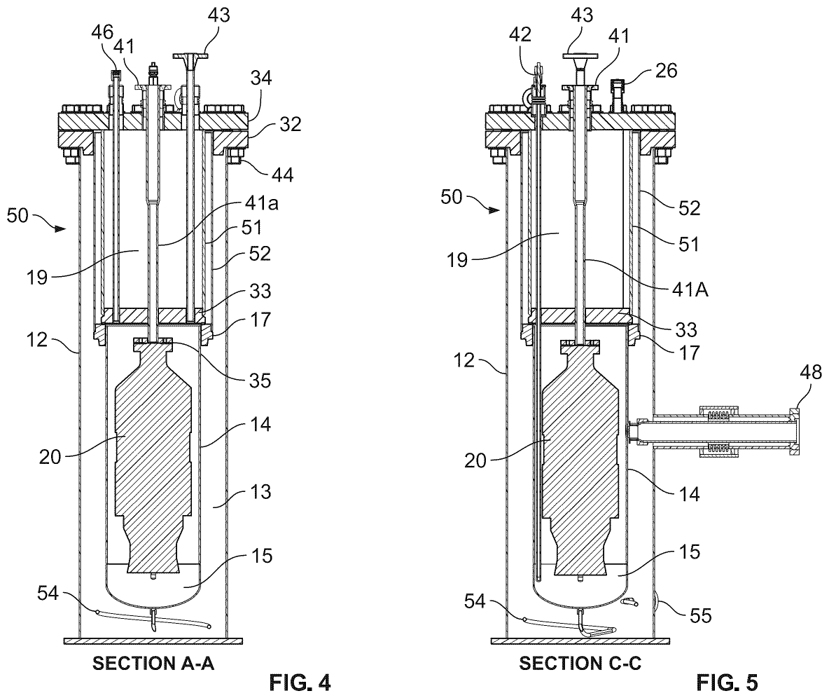

Sump assembly 10 also includes electrical feed 43 that provides a power source to pump 20. As shown in FIG. 4, electrical feed 43 is coupled to top plate 34. Electrical feed extends through top plate 34, vacuum area 19, and intermediate flange 33. The physical connection of power to pump 20 may be of a standard design and is not depicted herein.

Further, as shown in FIG. 5, sump assembly 10 includes liquid level sensor 42 that is configured to detect a liquid level of cryogenic fluid inside internal sump 15. For example, liquid level sensor 42 is a capacitive probe, float gauge, and/or other type of sensor capable of detecting liquid level of cryogenic fluid inside internal sump 15. In the illustrated example, liquid level sensor 42 is coupled to top plate 34. Liquid level sensor 42 extends through top plate 34, vacuum area 19, and intermediate flange and into internal sump 15 adjacent pump 20.

Additionally or alternatively, sump assembly 10 includes a pressure gauge 47 (FIG. 1) that is configured to detect the liquid level of cryogenic fluid inside internal sump 15. That is, pressure gauge 47 is configured as a liquid level sensor. For example, pressure gauge 47 is a differential pressure gauge that determines the liquid level of cryogenic fluid inside internal sump 15 by comparing a measured pressure of gas inside internal sump 15 and a measured pressure of liquid inside internal sump 15. In the illustrated example, pressure gauge 47 measures the pressure of liquid inside internal sump 15 by measuring the pressure of the liquid at tubing 54 and/or drain 55. Further, sump assembly 10 includes sump connection 46 through which pressure gauge 47 measures the pressure of gas inside internal sump 15. As shown in FIG. 4, sump connection 46 is mounted to and extends thorough and between top plate 34 and intermediate flange 33. That is, sump connection 46 extends to and is fluidly connected to the gaseous portion of internal sump 15.

In the illustrated example, discharge connection 41, liquid level sensor 42, electrical feed 43, and vacuum pumpout 26 are secured to top plate 34 and/or intermediate flange 33 of upper body 30 without being connected to any portion of lower body 25. In turn, discharge connection 41, liquid level sensor 42, electrical feed 43, and vacuum pumpout 26 are part of upper body 30 and do not prevent upper body 30 from being removed from lower body 25 to provide easy access to and removability of pump 20.

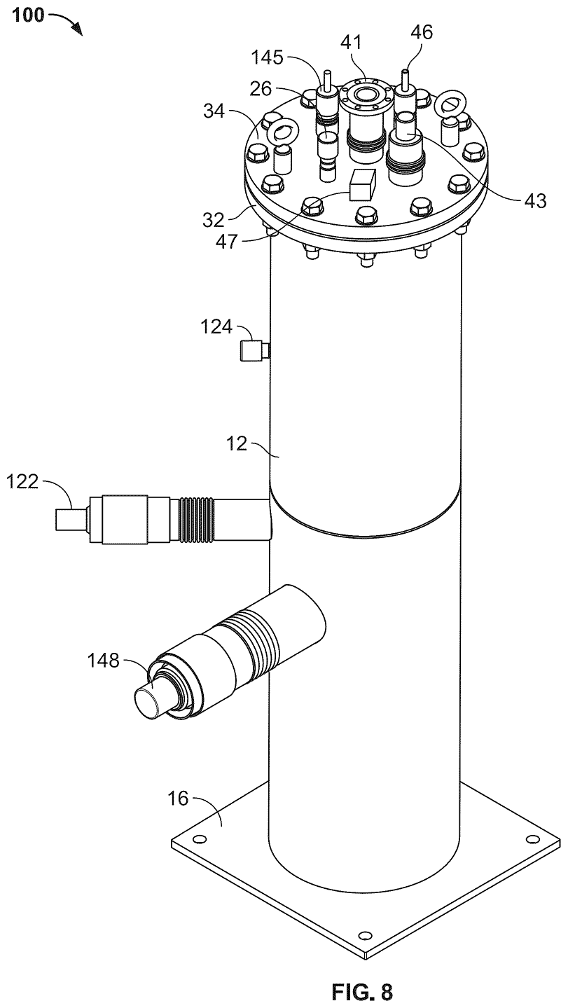

Turning to FIGS. 8-11, one can see another exemplary cryogenic pump and sump assembly 100 (also referred to as “sump assembly”). Sump assembly 100 includes many components that are identical and/or substantially similar to those of sump assembly 10. Those components of sump assembly 100 use the same reference numerals in FIGS. 8-11 as they are numbered for sump assembly 10 of FIGS. 1-7. Further, because those elements have been disclosed in detail with respect to FIGS. 1-7, those elements are not described again with respect to FIGS. 8-11 for concision. Instead, only elements of sump assembly 100 that are new or modified, with respect to sump assembly 10, are further detailed below.

As shown in FIG. 8, sump assembly 100 includes vent 122. Like vent 22 of sump assembly 10, vent 122 extends through shell 12 and is sealingly connected to casing 14 to fluidly connect to internal sump 15. Vent 122 is fluidly connected to internal sump 15 to provide venting of excess fluid to an external location. In the illustrated example, vent 122 has a field can connection to facilitate a permanent installation of sump assembly 10 in the field.

Sump assembly 100 also includes inlet 148. Like inlet 48 of sump assembly 10, inlet 148 extends through shell 12 and is sealingly connected to casing 14 to fluidly connect internal sump 15 to an external source tank. That is, cryogenic fluid is ported into internal sump 15 via inlet 148. In the illustrated example, inlet 148 has a field can connection to facilitate a permanent installation of sump assembly 10 in the field.

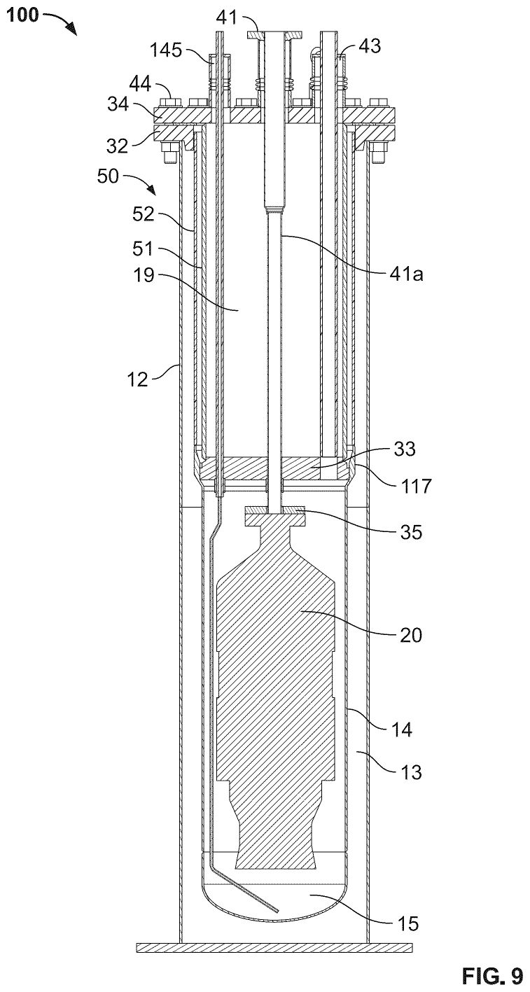

As shown in FIGS. 8-9, sump assembly 100 does not include liquid level sensor 42 for detecting the liquid level of cryogenic fluid in internal sump 15 or tubing 54 and drain 55 for draining of fluid from internal sump 15. Instead, sump assembly 100 of the illustrated example includes siphon 145. As shown in FIG. 9, siphon 145 is connected to top plate 34 and intermediate flange 33. Siphon 145 extends through top plate 34, vacuum area 19, and intermediate flange 33. Siphon 145 further extends into internal sump 15 and toward a bottom portion of internal sump 15 to siphon cryogenic liquid to be drained from internal sump 15. Additionally, pressure gauge 47 measures the pressure of liquid inside internal sump 15 via siphon 145, while measuring the pressure of gas inside internal sump 15 via sump connection 46.

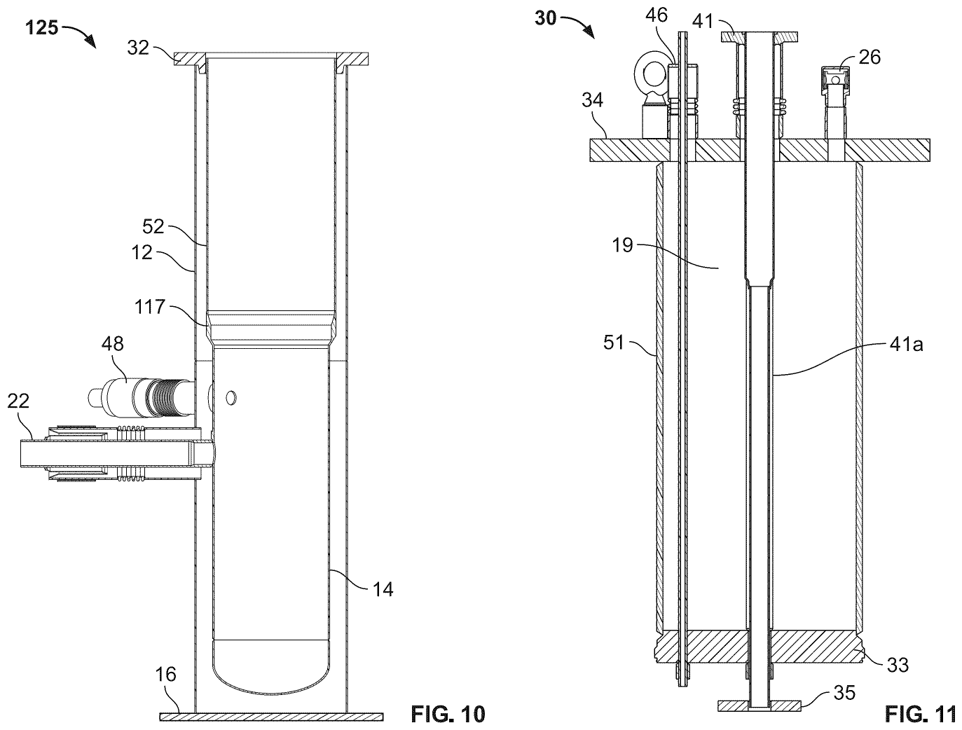

As shown in FIGS. 9-10, sump assembly 100 includes sealing body 117 that is shaped differently than sealing body 17 of sump assembly 10. Similar to sealing body 17, sealing body 117 is sealingly fixed a bottom portion of external sleeve 52 and a top portion of casing 14. In contrast to sealing body 17, an inner radial surface of sealing body 117 is configured to form a radial seal with an outer radial surface of intermediate flange 33 to deter gaps from forming between sealing body 117 and intermediate flange 33 due to shrinkage.

Exemplary embodiments in accordance with the teachings herein are disclosed below.

Embodiment 1. A sump assembly for cryogenic fluid includes an external shell that is insulated. The external shell includes an upper end and a lower end and defines an internal volume. The sump assembly includes a top plate positioned adjacent to the upper end of the external shell and an intermediate flange disposed in the internal volume of the external shell. The intermediate flange is positioned below and spaced apart from the top plate. The sump assembly includes an internal sleeve sealingly fixed to and extending vertically between the top plate and the intermediate flange. The internal sleeve, the top plate, and the intermediate flange define an upper vacuum area in which an upper vacuum is formed for insulation. The sump assembly includes a casing that is disposed in the internal volume of the external shell and forms an internal sump. The casing is positioned below and sealingly engages the intermediate flange. The casing and the external shell at least partially define an outer vacuum area in which an outer vacuum is formed for further insulation. At least a portion of the outer vacuum area is located radially between the casing and the external shell. The sump assembly includes a pump submerged in the internal sump.

Embodiment 2. The sump assembly of embodiment 1, further including a lower body that includes the external shell and the casing.

Embodiment 3. The sump assembly of embodiment 2, wherein the lower body further includes a mounting plate sealingly fixed to the lower end of the external shell. The mounting plate is configured to be mounted onto an external surface. The lower body further includes a top flange sealingly fixed to the upper end of the external shell. The top plate is configured to couple to the top flange.

Embodiment 4. The sump assembly of embodiment 3, wherein the lower body further includes an external sleeve sealingly fixed to and extending downwardly from the top flange. The external sleeve is positioned radially between the internal sleeve and the external shell to create a radial buffer between the upper vacuum area and an upper portion of the outer vacuum area.

Embodiment 5. The sump assembly of embodiment 4, wherein the lower body further includes a sealing body that is sealingly fixed to and between the external sleeve and the casing. The sealing body sealingly engages the intermediate flange.

Embodiment 6. The sump assembly of any embodiments 2-5, further including an upper body that is removable from the lower body to provide easy access to the pump without further disassembly.

Embodiment 7. The sump assembly of embodiment 6, wherein the upper body includes the top plate, the intermediate flange, and the internal sleeve.

Embodiment 8. The sump assembly of embodiment 7, wherein the top plate of the upper body is configured to be removably fastened to the lower body. The internal sleeve and the intermediate flange extend into the internal volume of the external shell when the top plate is coupled to the lower body.

Embodiment 9. The sump assembly of any of embodiments 1-8, further including a discharge connection for discharging the cryogenic fluid. The discharge connection is coupled to the top plate and fluidly connected to the pump. The sump assembly further includes a discharge pipe extending through the top plate, the upper vacuum area, and the intermediate flange to fluidly connect the discharge connection to the pump.

Embodiment 10. The sump assembly of embodiment 9, further including a pump flange that is fixed to an end of the discharge pipe that extends below the intermediate flange. A top end of the pump is coupled to the pump flange.

Embodiment 11. The sump assembly of embodiment 9 or 10, wherein a length of the internal sleeve causes the pump and the discharge connection to be spaced apart by at least a height of the upper vacuum extending between the intermediate flange and the top plate to minimize heat transfer as the cryogenic fluid passes through the discharge pipe for discharge from the discharge connection.

Embodiment 12. The sump assembly of any of embodiment 1-11, further including an electrical feed that is coupled to the top plate and extends through the top plate, the upper vacuum area, the intermediate flange to enable electrical power to be provided to the pump.

Embodiment 13. The sump assembly of any of embodiment 1-12, further including a liquid level sensor configured to detect a liquid level of the cryogenic fluid inside the internal sump.

Embodiment 14. The sump assembly of any of embodiment 1-13, further including an upper vacuum pumpout disposed on the top plate and configured to create the upper vacuum in the upper vacuum area.

Embodiment 15. The sump assembly of any of embodiment 1-14, further including an outer vacuum pumpout that extends through the external shell and is sealingly connected to the casing. The outer vacuum pumpout is configured to create the outer vacuum in the outer vacuum area.

Embodiment 16. A sump assembly for cryogenic fluid includes a lower body defining an internal sump, a pump submerged in the internal sump, and an upper body configured to couple to the lower body. The upper body defines an upper vacuum area in which an upper vacuum is formed for insulation of the cryogenic fluid. The upper body and the lower body define an outer vacuum area when the upper body is coupled to the lower body. An outer vacuum is formed in the outer vacuum area for further insulation of the cryogenic fluid. The upper body is removable from the lower body to provide easy access to the pump for servicing without further disassembly.

Embodiment 17. The sump assembly of embodiment 16, wherein the lower body further includes a mounting plate configured to be mounted onto an external surface.

Embodiment 18. The sump assembly of embodiment 16 or 17, wherein the lower body includes an external shell that is insulated, and wherein the external shell defines an internal volume in which the pump is disposed.

Embodiment 19. The sump assembly of embodiment 18, wherein the lower body further includes a casing that forms the internal sump. The casing and the external shell at least partially define the outer vacuum area in which the outer vacuum is formed. At least a portion of the outer vacuum area is located radially between the casing and the external shell.

Embodiment 20. The sump assembly of embodiment 19, wherein the lower body includes a top flange. The upper body is configured to couple to the top flange.

Embodiment 21. The sump assembly of embodiment 20, wherein the lower body further includes an external sleeve sealingly fixed to and extending downwardly from the top flange. The external sleeve is positioned radially between the upper vacuum area and the outer vacuum area to create a radial buffer between the upper vacuum area and an upper portion of the outer vacuum area.

Embodiment 22. The sump assembly of embodiment 21, wherein the lower body further includes a sealing body that is sealingly fixed to and between the external sleeve and the casing.

Embodiment 23. The sump assembly of any of embodiments 16-22, wherein the upper body includes a top plate that is configured to couple to the lower body.

Embodiment 24. The sump assembly of embodiment 23, wherein the upper body further includes an intermediate flange positioned below and spaced apart from the top plate. The intermediate flange extends into the lower body when the upper body is coupled to the lower body.

Embodiment 25. The sump assembly of embodiment 24, wherein the upper body further includes an internal sleeve sealingly fixed to and extending vertically between the top plate and the intermediate flange.

Embodiment 26. The sump assembly of embodiment 25, wherein the internal sleeve, the top plate, and the intermediate flange define the upper vacuum area in which the upper vacuum is formed.

Embodiment 27. The sump assembly of any of embodiments 16-25, further including a discharge connection fluidly connected to the pump for discharging the cryogenic fluid, a discharge pipe extending between and fluidly connecting the discharge connection to the pump, and a pump flange fixed to an end of the discharge pipe and to which a top end of the pump is coupled.

Embodiment 28. The sump assembly of any of embodiments 16-27, further including an electrical feed configured to enable electrical power to be provided to the pump.

Embodiment 29. The sump assembly of any of embodiments 16-28, further including a liquid level sensor configured to detect a liquid level of the cryogenic fluid inside the internal sump.

Embodiment 30. The sump assembly of any of embodiments 16-29, further including an upper vacuum pumpout configured to create the upper vacuum in the upper vacuum area and an outer vacuum pumpout configured to create the outer vacuum in the outer vacuum area.

What is claimed is:

1. A sump assembly for cryogenic fluid, the sump assembly comprising:
an external shell that is insulated, wherein the external shell includes an upper end and a lower end and defines an internal volume;
a top plate positioned adjacent to the upper end of the external shell;
an intermediate flange disposed in the internal volume of the external shell, wherein the intermediate flange is positioned below and spaced apart from the top plate;
an internal sleeve sealingly fixed to and extending vertically between the top plate and the intermediate flange, wherein the internal sleeve, the top plate, and the intermediate flange define an upper vacuum area in which an upper vacuum is formed for insulation;
a casing that is disposed in the internal volume of the external shell and forms an internal sump, wherein the casing is positioned below and sealingly engages the intermediate flange, and wherein the casing and the external shell at least partially define an outer vacuum area in which an outer vacuum is formed for further insulation, wherein at least a portion of the outer vacuum area is located radially between the casing and the external shell; and
a pump submerged in the internal sump.

2. The sump assembly of claim 1, further comprising a lower body that includes the external shell and the casing.

3. The sump assembly of claim 2, wherein the lower body further comprises:
a mounting plate sealingly fixed to the lower end of the external shell, wherein the mounting plate is configured to be mounted onto an external surface; and
a top flange sealingly fixed to the upper end of the external shell, wherein the top plate is configured to couple to the top flange.

4. The sump assembly of claim 3, wherein the lower body further comprises an external sleeve sealingly fixed to and extending downwardly from the top flange, wherein the external sleeve is positioned radially between the internal sleeve and the external shell to create a radial buffer between the upper vacuum area and an upper portion of the outer vacuum area.

5. The sump assembly of claim 4, wherein the lower body further comprises a sealing body that is sealingly fixed to and between the external sleeve and the casing, wherein the sealing body sealingly engages the intermediate flange.

6. The sump assembly of claim 2, further comprising an upper body that is removable from the lower body to provide easy access to the pump without further disassembly.

7. The sump assembly of claim 6, wherein the upper body comprises the top plate, the intermediate flange, and the internal sleeve.

8. The sump assembly of claim 7, wherein the top plate of the upper body is configured to be removably fastened to the lower body, and wherein the internal sleeve and the intermediate flange extend into the internal volume of the external shell when the top plate is coupled to the lower body.

9. The sump assembly of claim 1, further comprising:
a discharge connection for discharging the cryogenic fluid, wherein the discharge connection is coupled to the top plate and fluidly connected to the pump; and
a discharge pipe extending through the top plate, the upper vacuum area, and the intermediate flange to fluidly connect the discharge connection to the pump.

10. The sump assembly of claim 9, further comprising a pump flange that is fixed to an end of the discharge pipe that extends below the intermediate flange, and wherein a top end of the pump is coupled to the pump flange.

11. The sump assembly of claim 9, wherein a length of the internal sleeve causes the pump and the discharge connection to be spaced apart by at least a height of the upper vacuum extending between the intermediate flange and the top plate to minimize heat transfer as the cryogenic fluid passes through the discharge pipe for discharge from the discharge connection.

12. The sump assembly of claim 1, further comprising an electrical feed that is coupled to the top plate and extends through the top plate, the upper vacuum area, the intermediate flange to enable electrical power to be provided to the pump.

13. The sump assembly of claim 1, further comprising a liquid level sensor configured to detect a liquid level of the cryogenic fluid inside the internal sump.

14. The sump assembly of claim 1, further comprising an upper vacuum pumpout disposed on the top plate and configured to create the upper vacuum in the upper vacuum area.

15. The sump assembly of claim 1, further comprising an outer vacuum pumpout that extends through the external shell and is sealingly connected to the casing, wherein the outer vacuum pumpout is configured to create the outer vacuum in the outer vacuum area.

16. A sump assembly for cryogenic fluid, the sump assembly comprising:
a lower body defining an internal sump;
a pump submerged in the internal sump; and
an upper body configured to couple to the lower body, wherein the upper body defines an upper vacuum area in which an upper vacuum is formed for insulation of the cryogenic fluid, wherein the upper body and the lower body define an outer vacuum area when the upper body is coupled to the lower body, wherein an outer vacuum is formed in the outer vacuum area for further insulation of the cryogenic fluid, and wherein the upper body is removable from the lower body to provide easy access to the pump for servicing without further disassembly.

17. The sump assembly of claim 16, wherein the lower body further comprises an external shell that is insulated and a casing that forms the internal sump, wherein the external shell defines an internal volume in which the pump is disposed, wherein the casing and the external shell at least partially define the outer vacuum area in which the outer vacuum is formed, and wherein at least a portion of the outer vacuum area is located radially between the casing and the external shell.

18. The sump assembly of claim 17, wherein the lower body further comprises a top flange and an external sleeve sealingly fixed to and extending downwardly from the top flange, wherein the upper body is configured to couple to the top flange, and wherein the external sleeve is positioned radially between the upper vacuum area and the outer vacuum area to create a radial buffer between the upper vacuum area and an upper portion of the outer vacuum area.

19. The sump assembly of claim 16, wherein the upper body comprises:
a top plate that is configured to couple to the lower body; and
an intermediate flange positioned below and spaced apart from the top plate, wherein the intermediate flange extends into the lower body when the upper body is coupled to the lower body.

20. The sump assembly of claim 19, wherein the upper body further comprises an internal sleeve sealingly fixed to and extending vertically between the top plate and the intermediate flange, wherein the internal sleeve, the top plate, and the intermediate flange define the upper vacuum area in which the upper vacuum is formed.
